(19) United States
(12) Patent Application Publication
(10) Pub. No.: US 2026/0005905 A1
(43) Pub. Date: Jan. 1, 2026

(54) PAPR REDUCTION FOR DATA PORTION OF ENHANCED LONG RANGE PPDU

(71) Applicant: NXP USA, Inc., AUSTIN, TX (US)

(72) Inventors: Rong Zhang, San Jose, CA (US); Rui Cao, Sunnyvale, CA (US); Hongyuan Zhang, Fremont, CA (US)

(21) Appl. No.: 19/253,398

(22) Filed: Jun. 27, 2025

Related U.S. Application Data
(60) Provisional application No. 63/665,149, filed on Jun. 27, 2024.
(60) Provisional application No. 63/668,115, filed on Jul. 5, 2024.

(51) Int. Cl. H04L 27/26; H04W 84/12

(52) U.S. Cl. CPC H04L 27/26132; H04L 27/2603; H04W 84/12

(57) ABSTRACT

Methods and apparatus are described for performing Enhanced Long Range (ELR) wireless communications. In a method, a wireless device generates an ELR physical layer protocol data unit (ELR PPDU), including generating a legacy preamble, an ELR preamble, and an ELR data portion including repeated ELR data. Generating the ELR data portion includes copying the ELR data in a plurality of Resource Units (RUs), including a first RU, a second RU, a third RU and a fourth RU. Generating the ELR data portion further includes partitioning each of the plurality of RUs, respectively, into a first RU portion and a second RU portion, and multiplying each of the first RU portions and second RU portions by a separate sequence entry of a masking sequence (e.g., [1 1 1 1 −1 1 1 −1]). The wireless device transmits the ELR PPDU over a wireless interface for reception by a second device.

### CROSS REFERENCE TO RELATED APPLICATIONS

The present U.S. Utility Patent Application claims priority pursuant to 35 U.S.C. § 119(c) to U.S. Provisional Application No. 63/665,149, entitled “PAPR REDUCTION METHODS FOR UHR ELR DATA PORTION”, filed Jun. 27, 2024, and U.S. Provisional Application No. 63/668,115, entitled “PAPR REDUCTION METHODS FOR UHR ELR DATA PORTION”, filed Jul. 5, 2024, the contents of both of which are hereby incorporated herein by reference in their entirety and made part of the present U.S. Utility Patent Application for all purposes.

### TECHNICAL FIELD

This disclosure relates generally to wireless communications, and more specifically to extended range signaling in wireless communications.

### BACKGROUND

Wireless local area networks (WLANs) have evolved rapidly over the past couple of decades, including WLANs that conform to the Institute of Electrical and Electronics Engineers (IEEE) 802.11 family of standards. In such WLANs, wireless devices including Access Points (APs) and client stations (STAs) wirelessly transmit and receive physical layer protocol data units (PPDUs). As various new services and deployment scenarios are supported by these wireless devices, the devices may be expected to transmit and receive signals over longer ranges. To extend the range that the PPDUs are transmitted and received, the IEEE 802.11ax and IEEE 802.11be amendments to the IEEE 802.11 standard define a legacy extended range PPDU. The IEEE 802.11b amendment also describes direct sequence spread spectrum (DSSS) communications to support an extended range.

### BRIEF DESCRIPTION OF THE DRAWINGS

One or more embodiments will now be described by way of example only with reference to the accompanying drawings, in which:

FIG. 1 illustrates an example of a wireless local area network (WLAN) in accordance with embodiments of the present disclosure;

FIG. 2 illustrates an example of an Enhanced Long Range (ELR) physical layer protocol data unit (PPDU) in accordance with an embodiment of the present disclosure;

FIG. 3A illustrates an example of generating the data portion of an Enhanced Long Range physical layer protocol data unit (ELR PPDU) using a first masking sequence in accordance with an embodiment of the present disclosure;

FIG. 3B illustrates an example of generating the data portion of an ELR PPDU using a second masking sequence in accordance with an embodiment of the present disclosure;

FIG. 3C illustrates an example of generating the data portion of an ELR PPDU using a third masking sequence in accordance with an embodiment of the present disclosure;

FIG. 3D illustrates an example of generating the data portion of an ELR PPDU using a fourth masking sequence in accordance with an embodiment of the present disclosure;

FIG. 3E illustrates an example of generating the data portion of an ELR PPDU using a fifth masking sequence in accordance with an embodiment of the present disclosure;

FIG. 4 is a logic diagram illustrating an example method for generating the data portion of an ELR PPDU in accordance with an embodiment of the present disclosure;

FIG. 5 illustrates an example of generating the data portion of an ELR PPDU using a masking sequence applied to duplicated and interleaved data in accordance with an embodiment of the present disclosure;

FIG. 6 illustrates an example of generating the data portion of an ELR PPDU using a per-tone masking sequence in accordance with an embodiment of the present disclosure;

FIG. 7 is a logic diagram illustrating an example method for generating the data portion of an ELR PPDU using a per-tone masking sequence in accordance with an embodiment of the present disclosure; and

FIG. 8 illustrates example functions associated with single carrier-frequency division multiplexed transmission in accordance with an embodiment of the present disclosure.

### DETAILED DESCRIPTION

As the number of Internet of Things (IoT) devices and other use cases continues to increase, Wi-Fi services have new opportunities to capitalize on diverse market needs. A key priority for future generations of Wi-Fi will be extending communication ranges to gain market share and create advantages over competing technologies. The various implementations described in the following description relate generally to extended range physical layer protocol data units (PPDU) formatting to support new wireless communication protocols, and more particularly to Enhanced Long Range (ELR) PPDU formats that support extended range wireless communication features associated with the IEEE 802.11bn amendment (also referred to as Ultra High Reliability or “UHR” or “Wi-Fi 8”), and future generations, of the IEEE 802.11 standard while also providing coexistence with legacy wireless devices. In some aspects, a wireless device generates an ELR physical layer protocol data unit (ELR PPDU), including generating a legacy preamble, an ELR preamble, and an ELR data portion including repeated ELR data. Generating the ELR data portion includes copying the ELR data in a plurality of Resource Units (RUs) (e.g., four RU-52s with 4× data duplication in the frequency domain). Generating the ELR data portion further includes partitioning each of the plurality of RUS, respectively, into a first RU portion and a second RU portion, and multiplying each of the first RU portions and second RU portions by a separate sequence entry of a masking sequence (e.g., [1 1 1 1 −1 1 1 −1]) to reduce the Peak-to-Average power Ratio (PAPR) of the ELR data portion. In another example, a masking sequence is applied to the RU portions on a per-tone basis.

Peak-to-Average Power Ratio (PAPR) refers to the ratio between the highest power level in a transmitted signal and it average power level. A high PAPR can result in signal distortion, power inefficiency, and increased hardware complexity. For example, high PAPR can necessitate powerful linear amplifiers or cause distortion and signal degradation when using non-linear amplifiers. Further, high PAPR can increase out-of-band transmissions that may interfere with adjacent channels.

Particular implementations of the subject matter described in the present disclosure can be applied to realize one or more of the following potential advantages. By enabling robust extended range communications, aspects of the described subject matter may support gains in data throughput and reliability achievable in accordance with various features of the IEEE 802.11bn amendment to the IEEE 802.11 standard. For example, an ELR PPDU according to the present disclosure may be used to overcome a link budget imbalance between downlink and uplink wireless communications and achieve higher data rates as compared to legacy extended range PPDU formats and protocols. An ELR PPDU according to the present disclosure may also reduce PAPR associated with direct duplication of data, improve the spectral characteristics of an ELR data stream, aid in mitigating electromagnetic interference, improve modulation efficiency by reducing DC bias, and support power saving features for high SNR receivers.

As used herein, the term “non-legacy” may refer to frame structures, physical layer (PHY) protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to frame structures, PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard.

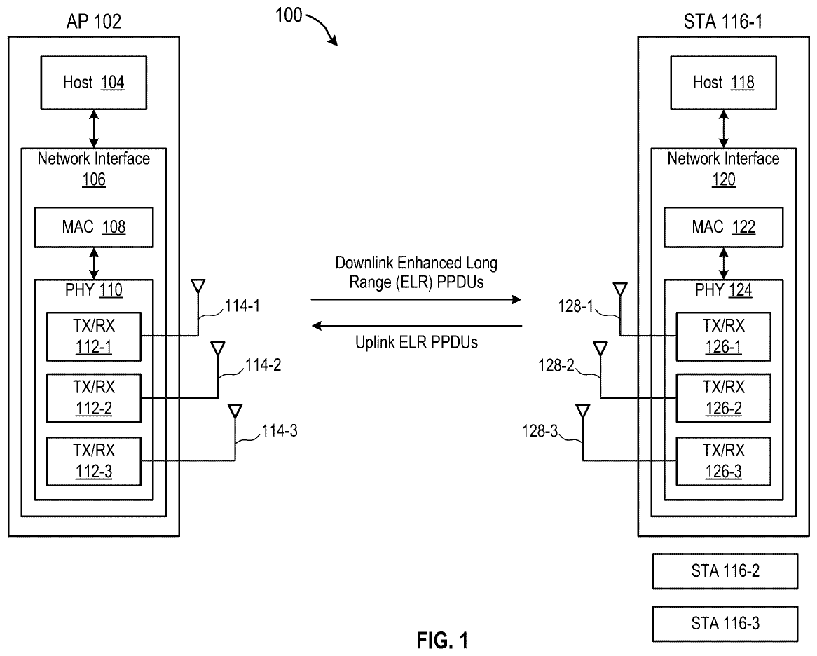

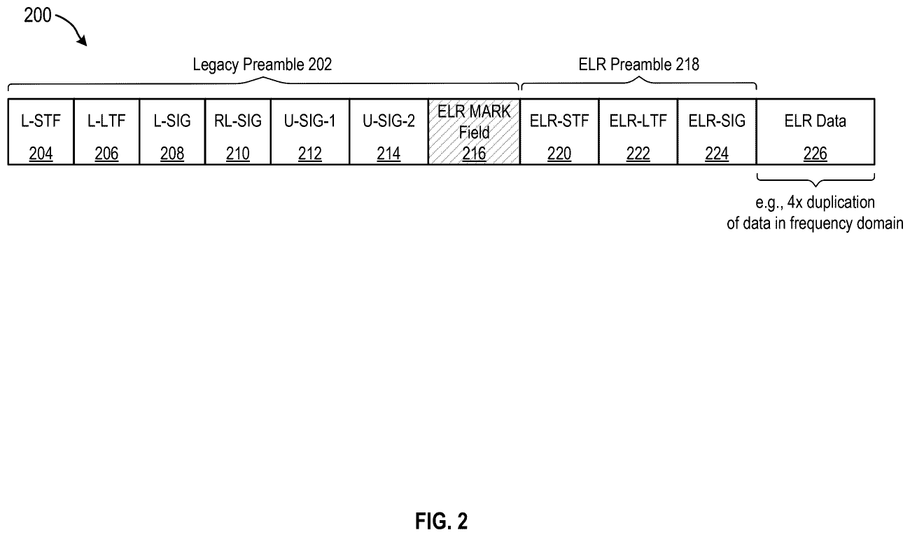

FIG. 1 illustrates an example of a wireless local area network (WLAN) 100 in accordance with embodiments of the present disclosure. The illustrated WLAN includes a wireless access point (AP) 102 and one or more wireless client stations 116 (e.g., STA 116-1, STA 116-2, and STA 116-3). The AP 102 of this example is configured to transmit downlink Enhanced Long Range (ELR) PPDUs and receive uplink ELR PPDUs. The ELR PPDUs can have a format and contents such as described in greater detail below with reference to any of the embodiments of FIGS. 2-7.

The illustrated AP 102 includes a host processor 104 coupled to a network interface 106. The network interface 106 includes a medium access control (MAC) processing unit 108 and a physical layer (PHY) processing unit 110. The PHY processing unit 110 includes a plurality of transceivers 112-1, 112-2 and 112-3 (e.g., transmitters and/or receivers) coupled to a respective plurality of antennas 114-1, 114-2 and 114-3. Although three transceivers 112 and three antennas 114 are illustrated in FIG. 1, in other embodiments the AP 102 includes other suitable numbers (e.g., 1, 2, 4, 5, etc.) of transceivers 112 and antennas 114 in other embodiments. In one embodiment, the MAC processing unit 108 and the PHY processing unit 110 are configured to operate in compliance with the IEEE 802.11bn amendment to the IEEE 802.11 standard.

The illustrated WLAN 100 also includes one or more wireless client stations 116. Three client stations 116 shown as 116-1, 116-2, and 116-3 are illustrated in FIG. 1, but the WLAN 100 may include other suitable numbers (e.g., 1, 2, 3, 5, 6, etc.) of client stations 116 in various scenarios and embodiments. At least one of the client stations 116 (e.g., client station 116-1) is configured to operate in compliance with the IEEE 802.11bn amendment to the IEEE 802.11 standard to communicate with the AP 102.

The client station 116-1 includes a host processor 118 coupled to a network interface 120 which includes a MAC processing unit 122 and a PHY processing unit 124. The PHY processing unit 124 includes a plurality of transceivers 126-1, 126-2 and 126-3, and the transceivers 126 are coupled to a respective plurality of antennas 128-1, 128-2 and 128-3. Although three transceivers 126 and three antennas 128 are illustrated in FIG. 1, the client station 116-1 includes other suitable numbers (e.g., 1, 2, 4, 5, etc.) of transceivers 126 and antennas 128 in other embodiments.

In various embodiments, the PHY processing unit 110 of the AP 102 is configured to generate and transmit (downlink) data units via the antenna(s) 114 over an air interface and the PHY processing unit 124 of the client station 116-1 is configured to receive the (downlink) data units via the antenna(s) 128 over the air interface. Similarly, the PHY processing unit 110 of the client station 116-1 is configured to generate and transmit (uplink) data units via the antenna(s) 128 and the PHY processing unit 110 of the AP 102 is configured to receive the (uplink) data units via the antenna(s) 114. In an example, the data units may be physical layer data units (PPDUs) for communicating data between the AP 102 and the client station 116-1 and the PPDUs (and fields therein) may be transmitted as a waveform in a downlink or uplink direction.

In embodiments, the network interface 106 of the AP 102 and the network interface 120 of one or more of the client stations 116 are configured to generate, transmit and receive ELR PPDUs having an extended range format to increase a range and/or a signal-to-noise (SNR) ratio associated with transmitting, receiving, classifying, and successfully decoding the ELR PPDUs exchanged in the WLAN 100. In an example, the ELR PPDUs are compliant with the IEEE 802.11bn (or later) amendment to the IEEE 802.11 standard, and include a legacy portion with legacy fields of one or more legacy IEEE 802.11 standards for backwards compatibility with legacy devices and an enhanced long range (ELR) portion with non-legacy fields of a non-legacy IEEE 802.11 standard which can be decoded by non-legacy devices.

The range extension features of the ELR PPDU may allow a client station 116 to decode the ELR portion of the ELR PPDU at an extended range. Decoding is a process of determining a valid pattern of bits of the received ELR PPDU referred to as decoded bits. In an example, the decoding may involve performing a parity check or CRC verification to determine whether the decoding is successful. A downlink ELR PPDU transmitted by AP 102 may solicit a response from a client station 116 in the form of an uplink ELR PPDU.

In an embodiment, when operating in single-user mode, the AP 102 transmits a data unit to a single client station (DL SU transmission), or receives a data unit transmitted by a single client station (UL SU transmission), without simultaneous transmission to or by any other client station. When operating in multi-user mode, the AP 102 transmits a data unit that includes multiple data streams for multiple client stations (DL MU transmission), or receives data units simultaneously transmitted by multiple client stations (UL MU transmission). For example, in multi-user mode, a data unit transmitted by the MLD includes multiple data streams simultaneously transmitted by the AP 102 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 102 and/or client station(s) 116 may be configured as a multi-link device (MLD). In another example, the AP 102 and/or one or more of the client stations 116 are configured to transmit and receive PPDUs over a plurality of wireless links, including one or more of a 2.4 Gigahertz (GHz) link, a 5 GHz link, a 6 GHz link, and a mmWave link (e.g., a 45 GHz link and/or a 60 GHz link).

In an example, the illustrated AP 102 may be connected to a distribution system (DS) through a distribution system medium (DSM). The distribution system may be a wired network or a wireless network that is connected to a backbone network such as the Internet. The DSM may be a wired medium (e.g., Ethernet cables, telephone network cables, or fiber optic cables) or a wireless medium (e.g., infrared, broadcast radio, cellular radio, or microwaves). Although some examples of the DSM are described, the DSM is not limited to the examples described herein. In another example, the AP 102 and/or client stations 116 may be implemented in a laptop, a desktop personal computer (PC), a mobile phone, remote sensor, or other communications device that supports at least one WLAN communications standard (e.g., at least one IEEE 802.11 standard).

In an example, one or more of the AP 102 and client stations 116 may be implemented with circuitry such as one or more of analog circuitry, mixed signal circuitry, memory circuitry, logic circuitry, and processing circuitry that executes code stored in a memory that when executed by the processing circuitry performs the disclosed functions. For example, the AP 102 and client stations 116 may include memory storing operational instructions (software, program instructions, computer instructions, etc.) and one or more processing modules, operably coupled to one or more wireless transceivers and the memory, configured to execute the operational instructions to generate an ELR PPDU.

In another example, a network interface 106/120 includes one or more integrated circuit (IC) devices. In this example, at least some of the functionality of a MAC processing unit 108/122 and at least some of the functionality of the PHY processing unit 110 can be implemented on a single IC device. As another example, at least some of the functionality of the MAC processing unit 108 is implemented on a first IC device, and at least some of the functionality of the PHY processing unit 110 is implemented on a second IC device.

In a further example, the ELR PPDU formats described herein can be utilized in 2.4 GHz, 5 GHZ, and 6 GHz bands for uplink communications, and in the 2.4 GHz band for downlink communications. In another example, a ELR PPDU may have a 20 MHz PPDU bandwidth, a single spatial stream, and utilize UHR-MCSs 0 or 1 with four times frequency domain duplication (e.g., over 52-tone RUs) in a primary 20 MHz channel.

FIG. 2 illustrates an example of an Enhanced Long Range (ELR) physical layer protocol data unit (PPDU) 200 in accordance with an embodiment of the present disclosure. The ELR PPDU 200 of this example includes a legacy preamble 202 (also referred to herein as a “legacy portion”), an ELR preamble 218, and an ELR Data field 226, which are transmitted as a waveform. The legacy preamble 202 includes legacy fields which legacy 802.11 devices are able to decode for co-existence while the ELR preamble 218 may include one or more ELR fields so that next generation devices (e.g., Wi-Fi 8 UHR devices) are able to transmit and receive data of the ELR Data field 226 with increased range and lower SNR. In an example, a bandwidth of the legacy preamble 202 and the ELR portions of the ELR PPDU 200 is the same to provide co-existence with legacy devices.

The legacy preamble 202 of this example includes a legacy short training field (L-STF) 204, a legacy long training field (L-LTF) 206, a legacy signal (L-SIG) field 208, a repeated L-SIG (RL-SIG) field 210, a U-SIG-1 field 212, and a U-SIG-2 field 214. U-SIG-1 field 212 and U-SIG-2 field 214 are collectively referred to herein as a U-SIG field. The L-STF 204 is used by a recipient device to detect the start of the PPDU or portion thereof and to establish orthogonal frequency division multiplexed/access (OFDM/A) symbol timing for data detection, i.e. frame acquisition and time synchronization. The L-LTF 206 is used for channel estimation/training for information detection. Channel estimation is a process of determining channel characteristics (e.g., a frequency response) of a channel in which the PPDU is transmitted. The L-SIG field 208 includes information for data decoding and coexistence such as a 12 bit packet length value (LENGTH), rate information, etc. In an example, LENGTH is signaled to spoof legacy devices for purposes of clear channel assessment (CCA), and non-legacy devices can decode a TXOP for CCA. In addition, a non-legacy device (e.g., an intended receiver) may also derive a Nsym (with may also be referred to as Length) value from the L-SIG field 208. However, as L-SIG LENGTH decoding may not be reliable, this information may be repeated in the ELR-SIG field 224.

In an example, the L-SIG field 208 may be repeated in time and the repetition is included in the repeated RL-SIG field 210 of the legacy preamble 202 such that the L-SIG field 208 is repeated twice. The repetition may allow increased range and SNR associated with receipt of the L-SIG field 208. To further extend the range, a transmission power of a waveform of one or more of the L-STF 204 and the L-LTF 206 may be boosted to 3 dB.

The U-SIG field in the legacy preamble 202 may include an indication of a version of the physical layer communication of IEEE 802.11 in a three-bit PHY identifier, an uplink/downlink flag, Basic Service Set (BSS) color, transmission (TX) opportunity (TXOP) duration, bandwidth, etc. In the illustrated ELR PPDU, the U-SIG field includes a U-SIG-1 field 212 and a U-SIG-2 field 214. In some embodiments, the U-SIG field can include one or more bits that are redefined to provide an ELR PPDU indication(s) and various bits that are utilized to provide ELR signaling (e.g., for ELR PPDU detection and classification).

The legacy preamble 202 may be modulated on an orthogonal frequency division multiplexed (OFDM) signal which defines subcarriers for transmitting the fields of the legacy preamble 202 and as a result range extension is also limited by a maximum peak to average ratio (PAPR) of the waveform representing the PPDU which IEEE 802.11 specifics. IEEE 802.11b defines a single-carrier binary sequence design which demonstrates range extension benefits over OFDM associated with 802.11ax and 802.11be. However, the carrier is only defined for a 2.4 GHz band and does not co-exist with IEEE 802.11a such that the format cannot be extended into a 5 GHz and 6 GHz band without also causing backward compatibility issues for legacy devices.

In some examples, one or more transition symbols may be optionally added after the U-SIG field in the legacy preamble 202 preceding the ELR preamble 218. In the illustrated example, an ELR-MARK field 216 is included. The ELR-MARK field 216 may be a symbol, such as an OFDM symbol, which spans a channel bandwidth and has a predefined duration, and may signal a transition between the U-SIG field and the ELR preamble 218. The optional nature of inclusion in the ELR PPDU 200 is illustrated by the cross-hatching. In an example, a non-legacy wireless device receiving the ELR PPDU 200 may need to determine a receiver state machine based on a U-SIG decoding CRC check. In the event that the U-SIG decoding fails, e.g., a CRC check does not pass, the wireless device needs to reset receive time domain parameters, such as CFO and sample frequency offset (SFO) compensation, while ELR preamble detection logic is still running. The ELR-MARK field 216 may provide some buffer time such that the ELR preamble will not arrive before the receive time domain parameters are reset. Thus, the ELR preamble detection will not be affected by the status of the legacy preamble detection. In one example, the ELR-MARK field 216 is defined as a signaling field (with predefined tone patterns). In another example, the ELR-MARK field 216 is a predefined sequence, which can further include a BSS color indication (e.g., a value of 0 to 63) or other unique sequence associated with an AP for use by receiving devices to determine if the received PPDU is an ELR PPDU and if the ELR PPDU is from OBSS. In a further example, the ELR-MARK field 216 carries a unique/defined sequence used to indicate an ELR PPDU format for purposes of further improving ELR PPDU classification.

The ELR-Mark field 216 is designed to assist in ELR PPDU classification at low SNR. A receiving device may operate in a “sniffer” mode to detect over-the-air packets. If the ELR-Mark field 216 includes BSS-Color information, the receiving device may need to check all sequences, which may add complexity (and cause a receiver PHY to no longer be agnostic to an operation mode). In addition, at higher SNR regions the U-SIG field content may be decodable by a receiving device(s), and the ELR-Mark field 216 may not be required.

To achieve range extension, the legacy preamble 202 is followed by the ELR preamble 218. By appending the legacy preamble 202 to the ELR preamble 218, the ELR PPDU 200 is able to co-exist with the 802.11 legacy devices. In an example, a PPDU length in octets indicated in the L-SIG field 208 is backward compatible with legacy devices to detect the ELR PPDU 200 while the U-SIG field provides both backward and forward compatibility. For example, the U-SIG field is modulated with binary phase shift keying (BPSK), and the U-SIG field may indicate a “PHY version identifier” which indicates a PHY version. In a further example, the “PHY version identifier” subfield (bit index (B0-B2)) in the U-SIG-1 field 212 (or other subfields) can be redefined in various ways to indicate that a PPDU is formatted as an ELR PPDU.

An unintended receiver (ELR capable or non-ELR capable) can use ELR PPDU indications of such fields to stop processing to prevent unnecessary power consumption when the ELR PPDU is received and is not able to be processed, and set corresponding network allocation vector (NAV) values to delay any transmissions for at least a PPDU duration. In an example, an OBSS STA receiving an ELR PPDU can use a signaled BSS color value to stop further processing as a non-ELR PPDU. For an in-BSS STA receiving an ELR PPDU, an association ID (STA-ID) value carried in repurposed fields (e.g., subfields of a U-SIG/HE-SIG-A field) can be used as a criteria to stop further processing for a EHT/UHR non-ELR PPDU. In an example, an in-BSS STA receives an ELR PPDU having a (Phy) Version Identifier value of 1 (indicating UHR), a matching BSS color, a PPDU Type and Compression Mode value of 3 (indicating an ELR PPDU format), and a valid CRC, but also a STA-ID that does not match its STA-ID. In this example, the in-BSS STA can stop further processing of the ELR PPDU (e.g., if the RSSI of the PPDU is above a threshold value).

The ELR portion of the illustrated example includes an ELR preamble 218 and a ELR Data field 226. The ELR preamble 218 includes an ELR short training field (ELR-STF) 220, an ELR long training field (ELR-LTF) 222, and an ELR signal (ELR-SIG) field 224. The ELR-STF 220 may be a predefined binary sequence used to detect the start of the ELR portion and provide symbol timing for data detection, i.e. frame acquisition and time synchronization. In one embodiment, the ELR-STF 220 consists of two parts: one binary sequence for synchronization followed by one binary sequence for STF ending and ELR-LTF 222 may not be included. In another embodiment, the ELR-STF 220 consists of one binary sequence followed by ELR-LTF 222. If the receiver is not able to detect the L-STF 204, the receiver will attempt to detect the ELR-STF 220. The ELR-LTF 222 defines a binary sequence for channel estimation/training by a receiver. In some examples, this field may be omitted for certain modulation schemes such as differential encoding for 802.11b.

The ELR-SIG field 224 includes information for data decoding. The ELR-SIG field 224 may include various parameters including a modulation and coding scheme (MCS) subfield, a coding subfield that indicates whether BCC or LDPC is used, a TXOP subfield, a number of symbols (Nsym) or Length subfield that indicates a number of ELR data symbols, a cyclic redundancy check (CRC), a BSS Color subfield, an association ID (STA-ID) subfield, an LDPC Extra Symbol or Segment subfield, a Pre-FEC Padding subfield, a CRC subfield, a Tail bits subfield(s), etc. In an example, the ELR-SIG field 224 includes two symbols (i.e., an ELR-SIG-1 subfield and an ELR-SIG-2 subfield). Forward error correction (FEC) coding may be defined for the ELR-SIG field 224 to enhance reliability, e.g. binary convolutional coding (BCC). The ELR Data field 226 which follows the ELR Preamble 218 includes an ELR data payload defined by an ELR data binary sequence. Various methodologies are described herein for reducing the PAPR of the ELR Data field 226. In addition, forward error correction (FEC) coding may be defined to enhance data decoding reliability, e.g. BCC or low density parity check code (LDPC).

The ELR portion may be transmitted in various ways. In one example, a waveform representative of the binary sequences of the ELR portion may be defined with a low peak-to-average ratio (PAPR) such that the transmitter can increase the maximum transmit power to increase communication range or enhance receiver reception reliability. Because the legacy preamble 202 may already have a high PAPR, a power amplifier associated with the transceiver which transmits the ELR portion may back off by ˜10 dB to keep all samples which are to be transmitted in a linear region to accommodate the PAPR. The power amplifier may transmit the ELR portion with some peak samples into a non-linear region for range extension and an ER spectrum growth due to the non-linearity may result in a lower PAPR, close to 0 dB depending on binary sequence design. In an example, the ELR portion may be transmitted with a power similar to a peak power of the legacy preamble 202 with ˜10 dB gain, but in some cases, an increase in transmit power may be limited by a power spectral density. In another example, the transmit power of a waveform of the ELR portion may be set to a power boost such as 3 dB or the transmitter may set a power boost based on a historical transmit power range.

The binary sequence of the ELR-STF 220 may be modulated on a time domain waveform. Time domain modulation is defined as varying a modulation of a waveform over time. The binary sequence of the ELR-LTF 222, ELR-SIG field 224, and ELR Data field 226 may be transmitted based on single carrier (SC) time-domain multiplexing (TDM). A binary sequence may be directly modulated on a time domain waveform to generate different time domain signals for different binary sequences and additional spreading can be applied, e.g. 802.11b direct sequence spread spectrum (DSSS).

In another example, the modulation of one or more of the fields in the ELR preamble may be based on a single carrier (SC) frequency-domain multiplexing (FDM). Frequency domain multiplexing is defined as loading binary sequences to be transmitted onto subcarriers in a frequency band versus time domain signals, where different frequency bands may be assigned to different wireless devices. The ELR-STF 220 may be transmitted with one of the 802.11b DSSS, a zero correlation zone (ZCZ) spreading sequence, or a Golay sequence (defined in 802.11ad/ay). The ELR-LTF 222 may include a predefined binary sequence to estimate a channel of each subcarrier, and may be transmitted in a manner similar to the ELR-STF 220. The ELR-SIG field 224 and the ELR Data field 226 may be transmitted with SC-FDM. An LTF1 subfield of ELR-LTF 222 may be added before the ELR-SIG field 224 to indicate information to demodulate SIG content and an LTF2 subfield of the ELR-LTF 222 may be added to indicate information to demodulate ELR Data field 226 content. The information may indicate a tone mapping and the LTF2 may be included in the ELR-LTF 222 when a tone mapping of the subcarriers on which a binary sequence of the information are loaded and/or a bandwidth of the ELR Data field 226 is different from the ELR-SIG field 224. The tone mapping (also referred to herein as constellation mapping) may be a process of selecting subcarriers in a set of subcarriers to transmit the binary sequence, where a subcarrier or tone is a defined frequency or frequencies in a channel bandwidth such as a 20 MHz channel having an amplitude and a phase. In an example, a bit or bits of the sequence may be modulated on the tone such as by binary phase shift keying (BPSK) or quadrature phase shift keying (QPSK) to form a waveform.

As noted, constellation mapping refers to a process of assigning symbols/constellation points to digital data, and is an important step in modulation where binary data is mapped onto a complex plane (e.g., using QAM or PSK). Each symbol is assigned a unique position in a constellation diagram that represents amplitude and phase. Higher order modulation schemes have denser constellations and correspondingly increased data rates, but may also have a relatively high PAPR. The mapped symbols are transmitted as IQ signals (in-phase and quadrature components), and a receiving device decodes the constellations to recover the binary data. In addition to other challenges associated with enhanced long range communications, direct duplication of ELR data in the frequency domain can cause high PAPR, which can be mitigated using the PAPR reduction techniques described herein.

In certain of the embodiments described below, duplicated data is partitioned and or interleaved, and multiplied by a carefully selected masking sequence to reduce PAPR through bit randomization. By randomizing bit sequences, the masking process helps ensure that a data stream maintains good spectral characteristics, providing a more uniform signal profile to aid in extended range reception and mitigate electromagnetic interference. For example, application of the masking sequence helps maintain a balanced distribution of ones and zeroes in the ELR data as transmitted, enhancing error correction and signal integrity. Without the disclosed techniques, long sequences of identical bits (e.g., all ones or all zeros) are more likely to occur, which can result in DC bias and degraded modulation efficiency.

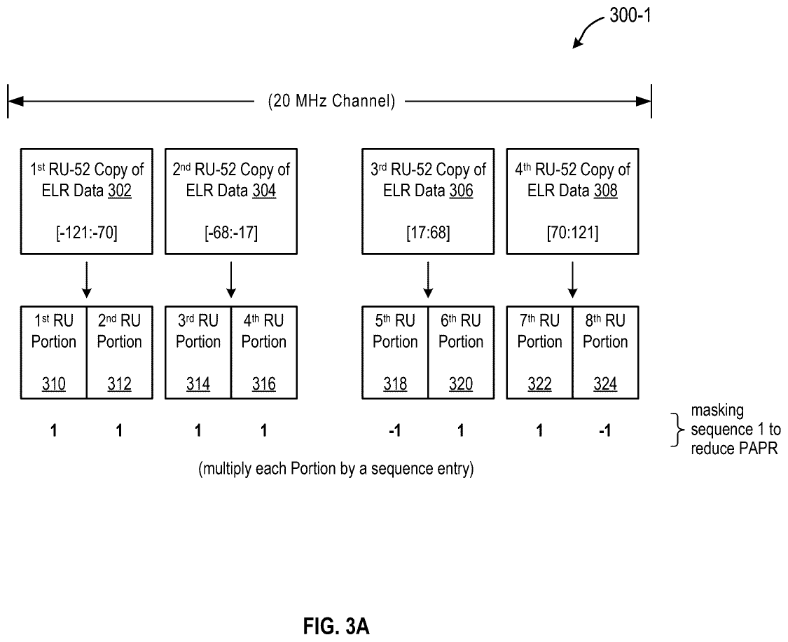

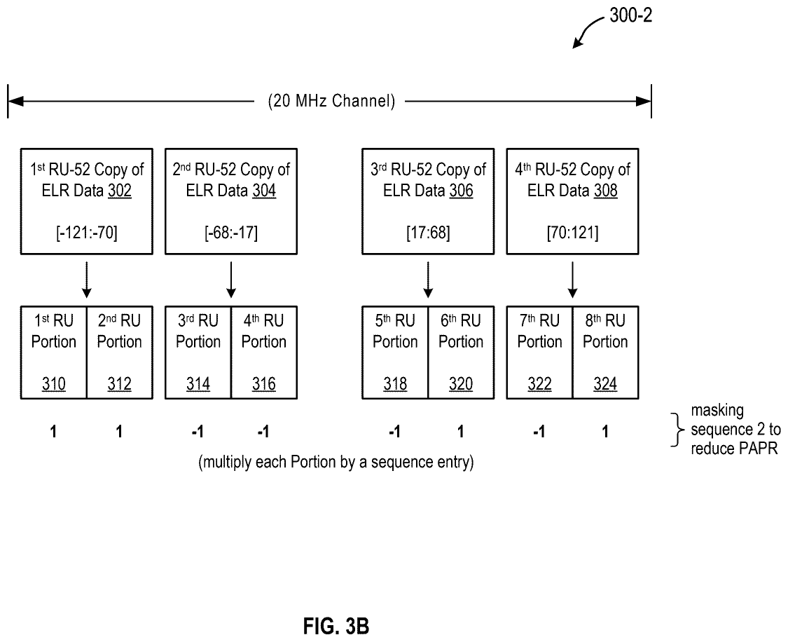

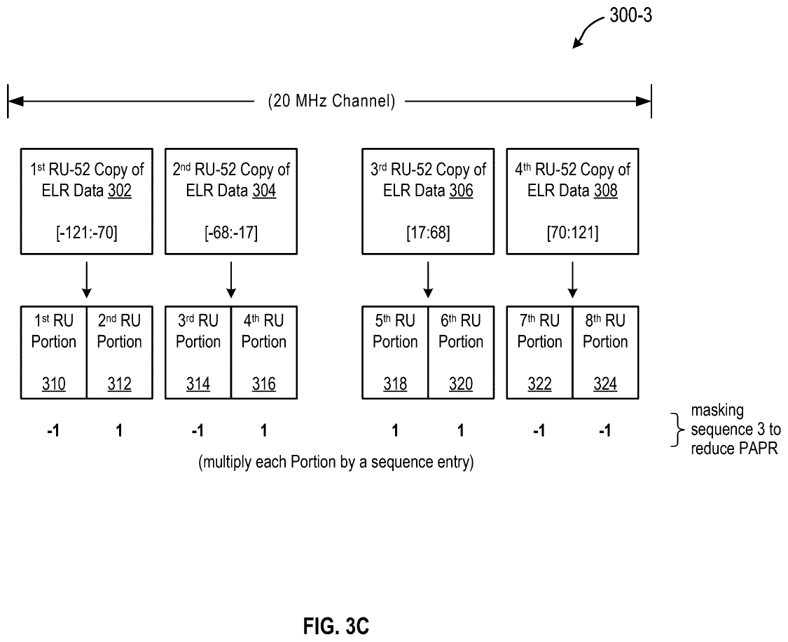

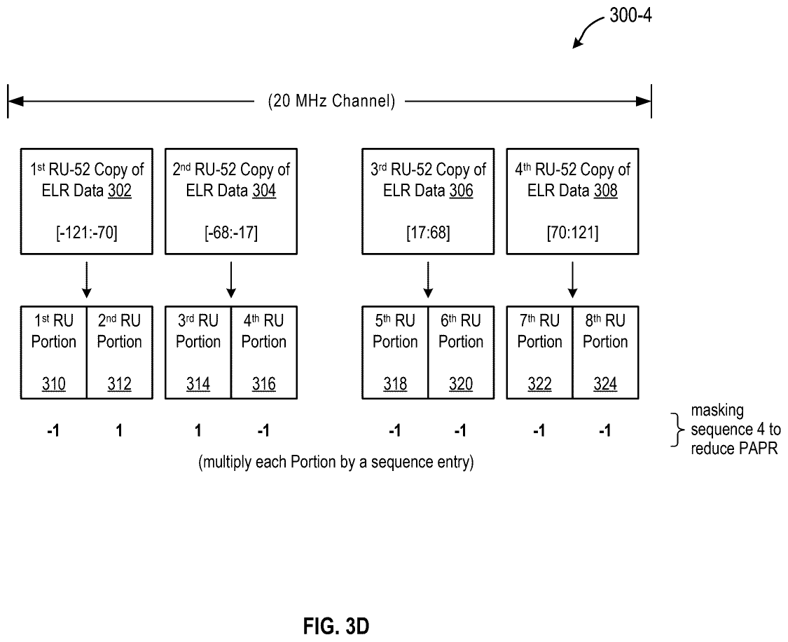

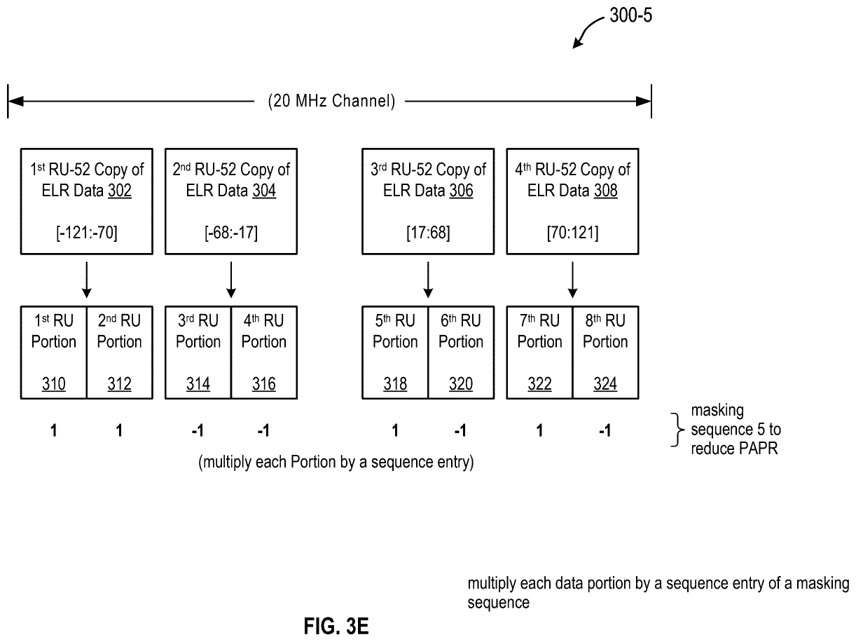

FIG. 3A illustrates an example 300-1 of generating, by a wireless device, the data portion of an Enhanced Long Range physical layer protocol data unit (ELR PPDU) using a first masking sequence in accordance with an embodiment of the present disclosure. In the illustrated example, the data portion of an ELR PPDU includes 4× frequency domain duplication of the ELR data in a 20 MHz channel, with each copy of the ELR data in a 52-tone resource unit (RU-52). In this example, a first copy of the ELR data is included in RU-52 302 (subcarrier index [−121:−70]), a second copy of the ELR data is included in RU-52 304 (subcarrier index [−68:−17]), a third copy of the ELR data is included in RU-52 306 (subcarrier index [17:68]), and a fourth copy of the data is included in RU-52 308 (subcarrier index [70:121]).

Briefly, an OFDM/OFDMA symbol is constructed of subcarriers, the number of which is generally a function of symbol length and PPDU bandwidth. Types of subcarriers include data subcarriers (used for data transmission), pilot subcarriers (used for phase information and parameter tracking), and unused subcarriers (e.g., DC subcarriers, Guard band subcarriers, and Null subcarriers). In Wi-Fi 6 and later versions of the 802.11 standard, a resource unit (RU) is a slice of a frequency band (or “subchannel”) that may be allocated for a wireless device's OFDMA data transmission. RUs can be configured in various sizes depending on channel width, such as 26 tones (also referred to as subcarriers), 52 tones, 106 tones, 252 tones, etc. For example, an “RU-52” refers to an RU spanning 52 tones/subcarriers within an OFDMA framework. An RU-52 may be formatted to include 48 tones used for carrying data and 4 tones reserved for pilot symbols. In general, the allocation of the 4 pilot symbols is standardized to provide reliable OFDMA operation, including providing reference signals across the subcarriers to aid in channel estimation and synchronization, even when a channel is partitioned into multiple RUs. In an example in which a subcarrier spacing of 78.125 kHz is used, an RU-52 spans approximately 4.0625 MHz of spectrum. In the time domain, the length of a symbol is inversely related to the subcarrier spacing. In the previous example, the RU-52 may have OFMD symbol duration of approximately 12.8 μs plus a guard interval (e.g., 0.8 μs).

Referring more particularly to FIG. 3A, the location of the illustrated RUs within a channel may be fixed. In the illustrated example, a subcarrier index of 0 corresponds to the DC tone. Negative subcarrier indices correspond to subcarriers with a frequency lower than the DC tone, and positive subcarrier indices correspond to subcarriers with a frequency higher than the DC tone. In another example, a middle 26-tone RU (e.g., an unused or null value RU) may be included at an index of [−16:−4, 4:16]. Although not separately illustrated, null subcarriers may be disposed between the RUs, and near the DC or edge tones to provide protection from transmit center frequency leakage, receiver DC offset, and interference from neighboring RUs. Such null subcarriers have zero energy.

In order to reduce the PAPR of the data portion of the ELR PPDU as transmitted, one or more of the copies of ELR data can be partitioned into RU portions (e.g., a first RU portion and a second RU portion) which are multiplied on a sub-band basis by a masking sequence following constellation mapping to generate the ELR Data field 226 of FIG. 2. In the illustrated example, RU-52 302 is partitioned into 1^{st} RU portion 310 and 2^{nd} RU portion 312, RU-52 304 is partitioned into 3^{rd} RU portion 314 and 4^{th} RU portion 316, RU-52 306 is partitioned into 5^{th} RU portion 318 and 6^{th} RU portion 320, and RU-52 308 is partitioned into 7^{th} RU portion 322 and 8^{th} RU portion 324.

In this example, a masking sequence 1 of size 8 ([1 1 1 1 −1 1 1 −1]) is defined for using in masking the various RU portions. Masking is the process of multiplying each data tone with a respective sequence entry of the masking sequence. In the illustrated masking process, 1^{st} RU portion 310 is multiplied by 1, 2^{nd} RU portion 312 is multiplied by 1, 3^{rd} RU portion 314 is multiplied by 1, 4^{th} RU portion 316 is multiplied by 1, 5^{th} RU portion 318 is multiplied by −1, 6^{th} RU portion 320 is multiplied by 1, 7^{th} RU portion 322 is multiplied by 1, and 8^{th} RU portion 324 is multiplied by −1. Other examples of masking sequences for reducing PAPR are described with reference to FIGS. 3B-3E.

FIG. 3B illustrates an example 300-2 of generating the data portion of an ELR PPDU using a second masking sequence in accordance with an embodiment of the present disclosure. In the illustrated example, the ELR data is duplicated and partitioned as described with reference to FIG. 3A. The RU portions 310-324 of this example are multiplied by a second masking sequence of [1 1 −1 −1 −1 1 −1 1] to reduce PAPR of the ELR Data field 226. In the illustrated masking process, 1^{st} RU portion 310 is multiplied by 1, 2^{nd} RU portion 312 is multiplied by 1, 3^{rd} RU portion 314 is multiplied by 1, 4^{th} RU portion 316 is multiplied by 1, 5^{th} RU portion 318 is multiplied by −1, 6^{th} RU portion 320 is multiplied by 1, 7^{th} RU portion 322 is multiplied by 1, and 8^{th} RU portion 324 is multiplied by −1.

FIG. 3C illustrates an example 300-3 of generating the data portion of an ELR PPDU using a third masking sequence in accordance with an embodiment of the present disclosure. In the illustrated example, the ELR data is duplicated and partitioned as described with reference to FIG. 3A. The RU portions 310-324 of this example are multiplied by a third masking sequence of [−1 1 −1 1 1 1 −1 −1] to reduce PAPR of the ELR Data field 226. In the illustrated masking process, 1^{st} RU portion 310 is multiplied by −1, 2^{nd} RU portion 312 is multiplied by 1, 3^{rd} RU portion 314 is multiplied by −1, 4^{th} RU portion 316 is multiplied by 1, 5^{th} RU portion 318 is multiplied by 1, 6^{th} RU portion 320 is multiplied by 1, 7^{th} RU portion 322 is multiplied by −1, and 8^{th} RU portion 324 is multiplied by −1.

FIG. 3D illustrates an example 300-4 of generating the data portion of an ELR PPDU using a fourth masking sequence in accordance with an embodiment of the present disclosure. In the illustrated example, the ELR data is duplicated and partitioned as described with reference to FIG. 3A. The RU portions 310-324 of this example are multiplied by a third masking sequence of [−1 1 1 −1 −1 −1 −1 −1] to reduce PAPR of the ELR Data field 226. In the illustrated masking process, 1^{st} RU portion 310 is multiplied by −1, 2^{nd} RU portion 312 is multiplied by 1, 3^{rd} RU portion 314 is multiplied by 1, 4^{th} RU portion 316 is multiplied by −1, 5^{th} RU portion 318 is multiplied by −1, 6^{th} RU portion 320 is multiplied by −1, 7^{th} RU portion 322 is multiplied by −1, and 8^{th} RU portion 324 is multiplied by −1.

FIG. 3E illustrates an example 300-5 of generating the data portion of an ELR PPDU using a fifth masking sequence in accordance with an embodiment of the present disclosure. In the illustrated example, the ELR data is duplicated and partitioned as described with reference to FIG. 3A. The RU portions 310-324 of this example are multiplied by a third masking sequence of [1 1 −1 −1 1 −1 1 −1] to reduce PAPR of the ELR Data field 226.In the illustrated masking process, 1^{st} RU portion 310 is multiplied by 1, 2^{nd} RU portion 312 is multiplied by 1, 3^{rd} RU portion 314 is multiplied by −1, 4^{th} RU portion 316 is multiplied by −1, 5^{th} RU portion 318 is multiplied by 1, 6^{th} RU portion 320 is multiplied by −1, 7^{th} RU portion 322 is multiplied by 1, and 8^{th} RU portion 324 is multiplied by −1.

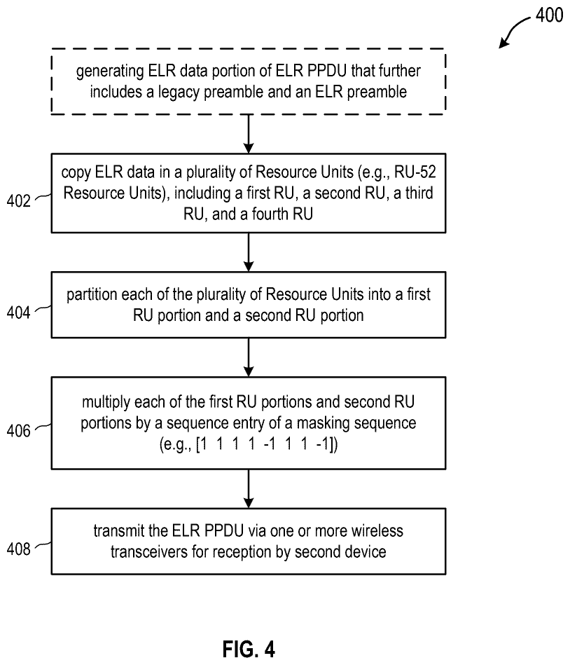

FIG. 4 is a logic diagram 400 illustrating an example method for generating the data portion of an ELR PPDU in accordance with an embodiment of the present disclosure. The illustrated functions can be performed by a wireless communication device, such as an AP 102 or a client station 116 described with reference to FIG. 1, to generate and transmit an ELR PPDU for reception by another wireless device. In the illustrated example, the wireless communications device generates the ELR data portion an ELR PPDU that further includes a legacy preamble and an ELR preamble. The legacy preamble comprises one or more of a legacy short training field (L-STF), a legacy long training field (L-LTF), a legacy signal (L-SIG) field, and a universal signaling (U-SIG) field. In an example, the U-SIG field may include at least one bit defined (e.g., in the 802.11bn amendment to the 802.11 standard) to provide an ELR PPDU indication that can be used by a receiving device to classify/identify an ELR PPDU.

The illustrated method begins at step 402 where the wireless communication device copies/duplicates ELR data in a plurality of resource units (RUs) of an ELR data portion. In an example, the data portion of an ELR PPDU includes 4× frequency domain duplication of the ELR data in a 20 MHz channel, with each copy of the ELR data in a 52-tone resource unit (RU-52). In this example, a first copy of the ELR data is included in a first RU, a second copy of the ELR data is included in a second RU, a third copy of the data is included in a third RU, and a fourth copy of the data is included in a fourth RU of the 20 MHz channel.

The method of this example continues at step 404, where the wireless communication device partitions each of the plurality of RUs into a respective first RU portion and a respective second RU portion. In an example of partitioning an RU, the first RU portion and the second RU portion are of equal size. In another example, the first RU portion and the second RU portion are unequal in size.

The method continues at step 406 where the wireless communication device multiplies each of the first RU portions and second RU portions by a sequence entry of a masking sequence. Various examples of a sequence masking process to reduce PAPR are described above with reference to FIGS. 3A-3E. In an example, a masking sequence of [1 1 1 1 −1 1 1 −1] is defined for using in masking the various RU portions. In further examples, the masking sequence is one of [1 1 −1 1 −1 1 −1 1], [−1 1 −1 1 1 1 −1 −1], [−1 1 1 −1 −1 −1 −1 −1], or [1 1 −1 −1 1 −1 1 −1].

The method continues at step 408, where the wireless communication device transmits the ELR PPDU, via one or more wireless transceivers, for reception by one or more other wireless communication devices (e.g., devices at an extended range). A recipient device may respond with a similarly constructed ELR PPDU. In an example, the ELR PPDU and fields thereof are transmitted as one or more waveforms, and one or more repetitions of a field may be transmitted to increase a signal-to-noise ratio (SNR) of the ELR portion of the ELR PPDU to facilitate decoding of the field. In addition to the PAPR reduction methodologies described herein, repetition of a field may increase an associated SNR by greater than 3 dB through averaging of signals associated with the repetitions.

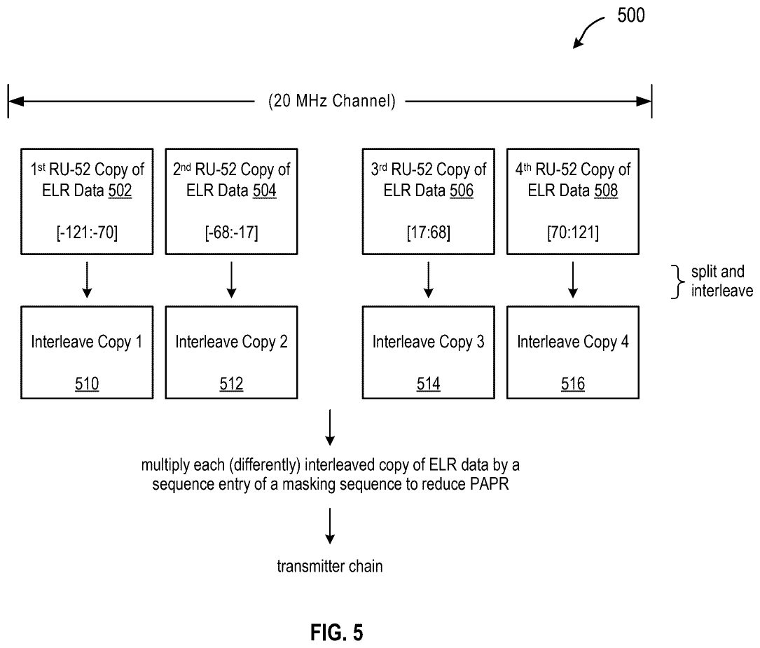

FIG. 5 illustrates an example 500 of generating the data portion of an ELR PPDU using a masking sequence applied to duplicated and interleaved data in accordance with an embodiment of the present disclosure. In the illustrated example, the data portion of an ELR PPDU includes 4× frequency domain duplication of the ELR data in a 20 MHz channel, with each copy of the ELR data in a 52-tone resource unit (RU-52). In this example, a first copy of the ELR data is included in RU-52 502 (subcarrier index [−121:−70]), a second copy of the ELR data is included in RU-52 504 (subcarrier index [−68:−17]), a third copy of the ELR data is included in RU-52 506 (subcarrier index [17:68]), and a fourth copy of the data is included in RU-52 508 (subcarrier index [70:121]).

In order to reduce the PAPR of the data portion of the ELR PPDU as transmitted, one or more of the copies can be split into portions and interleaved on a sub-band basis following constellation mapping. In an example, each copy of the data is interleaved on a per OFDM symbol basis using a different interleaving pattern to randomize bit patterns. In the illustrated example, the first copy of the ELR data is interleaved to generate interleave copy 1 510, the second copy of the ELR data is interleaved to generate interleave copy 2 512, the third copy of the ELR data is interleaved to generate interleave copy 3 514, and the fourth copy of the ELR data is interleaved to generate interleave copy 4 516.

Continuing with this example, a sequence masking step can be performed on the interleaved copies of ELR data to further randomize bit patterns. In an example, each of the interleave copies is multiplied by a sequence entry of a masking sequence. In general, the size of the masking sequence corresponds to the number of interleave copies. In the illustrated example, a 4 bit masking sequence composed of both 1's and −1's may be utilized. In another example, only data tones-not pilot tones-are multiplied by a sequence entry of the masking sequence. Following the sequence masking step, the ELR PPDU is forwarded to a transmit chain of the wireless communication device.

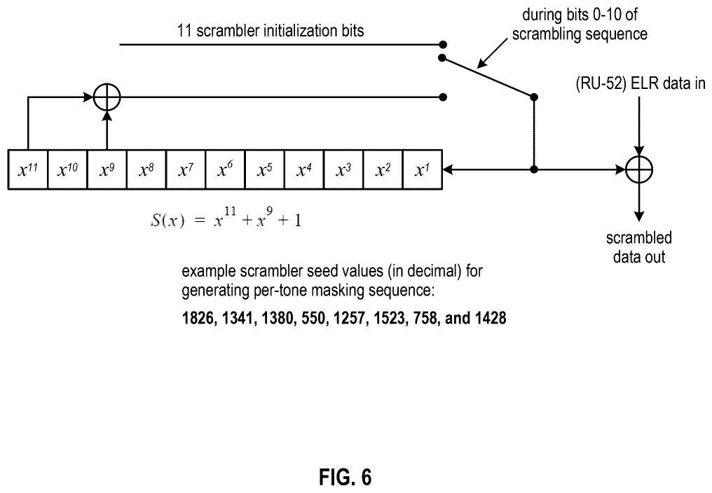

FIG. 6 illustrates an example of generating the data portion of an ELR PPDU using a per-tone masking sequence to reduce PAPR in accordance with an embodiment of the present disclosure. The data portion of an ELR PPDU of this example may include 4× frequency domain duplication of the ELR data in a 20 MHz channel. In an example, the scrambler operates using a pseudo-random sequence generator (“generator polynomial”) based on a linear feedback shift register. In operation, the scrambler is initialized with a predefined seed value, and each incoming ELR data bit is XORed with the generated scrambling sequence. A receiving device may apply the same scrambling sequence to recover the original data.

In the illustrated example, a generator polynomial S(x)=x¹¹+x⁹+1 such as defined in the 802.11be amendment to the IEEE 802.11 standard is utilized. In general, this scrambler utilizes feedback from the 11^{th} and 9^{th} bit positions in a shift register, and XORs the result with the current ELR data in bit to generate the next data out bit. In an example of operation, the scrambler is initialized with an 11-bit seed value (“scrambler initialization bits”). The scrambler receives the scrambler initialization bits, which may be based on a decimal seed value, and utilizes them to initialize the state bits in positions x¹ to x¹¹. For example, the scrambler performs an XOR operation between these bits and the first 11 data bits (e.g., of a Service field) to generate the first 11 scrambled data out bits. After the first 11 bits (bits 0-10) are processed, the illustrated switch “flips”, and the remaining bits of the scrambling sequence are generated. The generated bits are used to scramble the incoming data from bit 11 onwards. In this example, scrambler seed values (in decimal) may include: 1826, 1341, 1380, 550, 1257, 1523, 758, and 1428 or other appropriate seed value. When applied to data that is duplicated in four RU-52s including a total of 192 data tones, the generated masking sequence may be truncated to a size of 192. In an example, a generated sequence value of 0 is mapped to 1, and generated sequence value of 1 is mapped to −1. The illustrated scrambling process is distinct from any legacy scrambling process of the IEEE 802.11 standard.

In other examples, a different generator polynomial is used to generate the scrambling sequence. For example, a pre-802.11be scrambler such as S(x)=x⁷+x⁴+1 may be utilized. In this example, scrambler seed values (in decimal) may include: 22, 58, 56, 75, 12, 126, and 16. Other generator polynomials with appropriate seed values may be used to generate the scrambling sequence. In a further example, the illustrated masking process occurs prior to constellation mapping. In another example, the masking process occurs subsequent to constellation mapping.

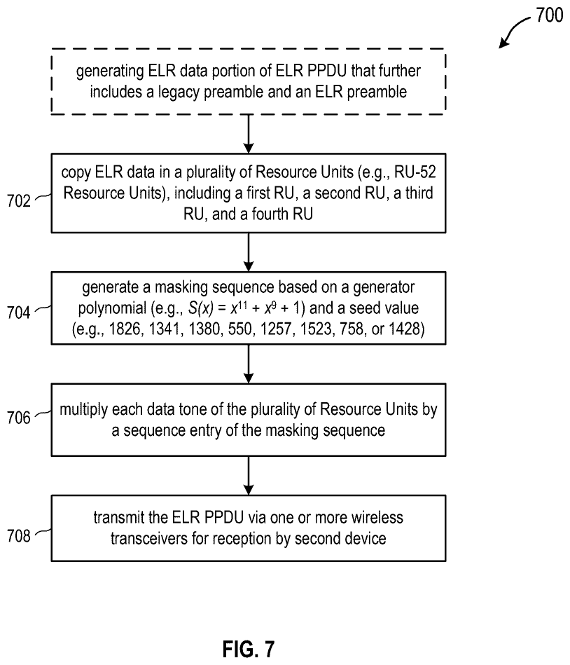

FIG. 7 is a logic diagram 700 illustrating an example method for generating the data portion of an ELR PPDU using a per-tone masking sequence to reduce PAPR in accordance with an embodiment of the present disclosure. The illustrated functions can be performed by a wireless communication device, such as an AP 102 or a client station 116 described with reference to FIG. 1, to generate and transmit an ELR PPDU for reception by another wireless device. In the illustrated example, the wireless communications device generates the ELR data portion an ELR PPDU that further includes a legacy preamble and an ELR preamble. The legacy preamble comprises one or more of a legacy short training field (L-STF), a legacy long training field (L-LTF), a legacy signal (L-SIG) field, and a universal signaling (U-SIG) field.

The illustrated method begins at step 702 where the wireless communication device copies/duplicates ELR data in a plurality of resource units (RUs) of an ELR data portion. In an example, the data portion of an ELR PPDU includes 4× frequency domain duplication of the ELR data in a 20 MHz channel, with each copy of the ELR data in a 52-tone resource unit (RU-52). In this example, a first copy of the ELR data is included in a first RU, a second copy of the ELR data is included in a second RU, a third copy of the data is included in a third RU, and a fourth copy of the data is included in a fourth RU of the 20 MHz channel.

The method of this example continues at step 704, where the wireless communication device generates a masking sequence based on a generator polynomial (e.g., S(x)=x¹¹+x⁹+1) and a scrambler seed value. As described in conjunction with FIG. 6, scrambler seed value (in decimal) may be one of 1826, 1341, 1380, 550, 1257, 1523, 758, and 1428 or other appropriate seed value. In other examples, a different generator polynomial and different scrambler seed value are utilized to generate the masking sequence.

The method continues at step 406 where the wireless communication device multiplies each ELR data tone of the plurality of RUs by a sequence entry of the masking sequence. The method continues at step 708, where the wireless communication device transmits the ELR PPDU, via one or more wireless transceivers, for reception by one or more other wireless communication devices (e.g., devices at an extended range). A recipient device may respond with a similarly constructed ELR PPDU.

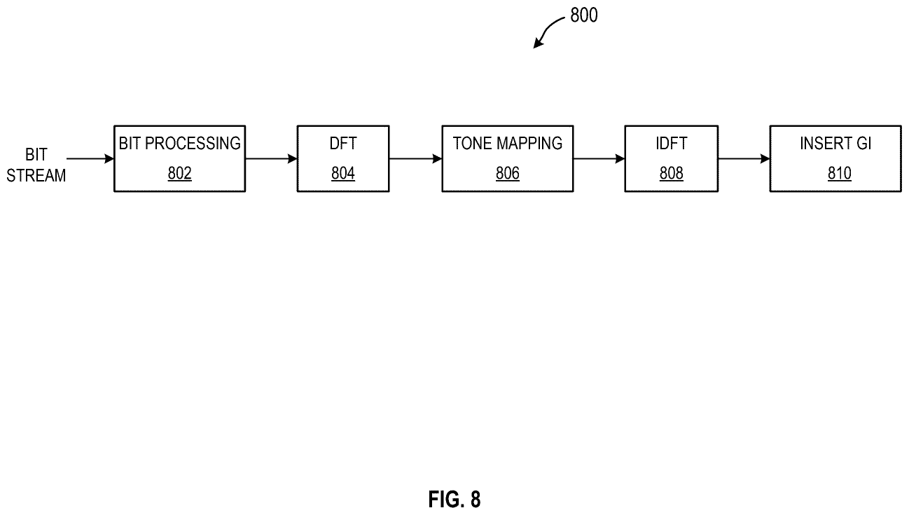

FIG. 8 illustrates example functions 800 associated with single carrier-frequency division multiplexed (SC-FDM) transmission of the ELR-SIG field 224 and ELR Data field 226 in accordance with an embodiment (e.g., using the ELR PPDU 200 of FIG. 2 as an example). The generalized functions 800 include bit processing 802 a binary sequence/stream associated with a field of the ELR PPDU, a discrete Fourier transform (DFT) 804, a tone mapping 806, an inverse DFT (IDFT) 808, and guard band insertion 810. At 802, the bit processing 802 performs one or more of encoding, scrambling, and/or modulation of a binary sequence of a field in a time domain. At 804, a DFT of the processed binary sequence of the ELR-SIG field 224/ELR Data field 226 is generated followed by a tone mapping 806 (or “constellation mapping”). The tone mapping 806 operates to populate the processed information bits in the frequency domain onto subcarriers which span a channel bandwidth such as a 20 MHz channel. Further, the population onto subcarriers may include mapping the processed binary sequence in the frequency domain to a resource unit which defines a plurality of tones for carrying the data. The tones can be contiguous or distributed. In an example, the bit processing 802 performs a precoding of the information bits prior to the tone mapping 806 to reduce a peak to average ratio (PAPR) of a waveform prior to transmission. Further reduction in PAPR can be achieved for the ELR data portion of an ELR PPDU via a symbol partitioning/interleaving and masking process following (or as part of) tone mapping 806. Examples of such a process are described above with reference to FIG. 3A-FIG. 7.

The IDFT 808 generates a SC-FDM symbol which spans a channel bandwidth and the guard band insertion 810 inserts guard intervals (e.g., to separate the symbols from interference). In an example, the guard interval for an ELR-SIG symbol is fixed at 0.8 us, 1.6 us or 3.2 us. SC-FDM can be easily extended to a multiple user case, where each user is assigned to a subset of tones in the resource unit, i.e., each wireless device modulates its data (after DFT) onto a different set of tones to facilitate extending range for uplink (UL) transmissions to multiple clients. For SC-FDM (A) mode, in one variant, the ELR-SIG field 224 may be transmitted with SC-TDM, while the ELR Data field 226 may be transmitted with SC-FDM.

A tone map for the ELR-SIG field 224 and ELR Data field 226 transmitted using SC-FDM may be arranged as a 20 MHz ELR PPDU. For example, ELR-SIG field 224 and ELR Data field 226 can be defined as one or more of an 802.11a/g tone plan, e.g., 64-point FFT with 48 loaded data tones and 4 pilot tones, an 802.11n/ac 20 MHz tone plan, e.g., 64-point FFT with 52 loaded data tones and 4 pilot tones (or 56 loaded data tones), or an 802.11ax/be 20 MHz tone plan, e.g., coded bit repetition using 256-point FFT and 234 loaded data tones and 8 pilot tones, or a sparse tone loading, e.g., 256-point FFT with 52 or 56 loaded data tones spaced every four tones (with channel estimation obtained from L-LTF, L-SIG, RL-SIG and/or an ELR-MARK subfield), etc. The tones may be subcarriers with a predefined frequency to carry indications of bits in fields of the ELR PPDU 200.

In another example, a wider bandwidth ELR PPDU 200 may be defined for a spectrum with a low power spectral density (PSD) requirement, e.g., 6 GHz low power indoor (LPI) operation. The ELR preamble may be transmitted in a 20 MHz bandwidth. To accommodate coexisting with wireless devices with different operating bandwidths, a wide bandwidth ELR preamble may be defined based on repetition of the 20 MHZ ELR preamble across entire signal BW, e.g., 80 MHz, or a per-20 MHz tone polarity change can be applied to a phase of a tone which is waveform modulated with one or more bits of a binary sequence in the repetitions of the ELR preamble. The polarity change of −1 may change the phase of a waveform by 180 degrees while a polarity change of 1 may not change the phase of a waveform by 180 degrees. The changes in polarity may be known to the receiver to remove the polarity changes during a decoding process. The term repetition, repeated, and similar variations as used herein with respect to a field means that tones of two fields are the same after any applied polarity/masking is removed.

In another example, the binary sequence of one or more fields of the ELR portion of the ELR PPDU 200 may be further repeated to improve communication range. Further, a binary sequence of the ELR portion may be defined as a waveform with OFDM modulation. The repetition may be in a time domain or in a frequency domain. In an example, the repetition (also referred to as duplication) may be a repetition of one or more orthogonal frequency division multiplexed/multiple access (OFDM/A) symbols in time with a same binary sequence, a repetition in frequency of a same binary sequence in one or more orthogonal frequency division multiplexed/multiple access (OFDM/A) symbols, or a repetition in time and frequency.

While the innovate aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative methods and apparatus illustrated in the drawings and described herein provide for reduced PAPR long range wireless communications. In an illustrative, non-limiting embodiment, a method for performing an Enhanced Long Range (ELR) wireless communication is provided. The method includes generating, by a first device, an ELR physical layer protocol data unit (ELR PPDU), including generating a legacy preamble, an ELR preamble, and an ELR data portion including repeated ELR data. Generating the ELR data portion includes copying the ELR data in a plurality of Resource Units (RUS), including a first RU, a second RU, a third RU and a fourth RU, and partitioning each of the plurality of RUs, respectively, into a first RU portion and a second RU portion. The method further includes multiplying each of the first RU portions and second RU portions by a separate sequence entry of a masking sequence. The first device of this method transmits the ELR PPDU over a wireless interface for reception by a second device.

The method of this embodiment includes optional aspects. With one optional aspect, the first RU, the second RU, the third RU and the fourth RU are RU-52 resource units of a 20 MHz channel. With another optional aspect, the masking sequence is defined to have a value of [1 1 1 1 −1 1 1 −1]. In a further optional aspect, the masking sequence is one of [1 1 −1 −1 −1 1 −1 1], [−1 1 −1 1 1 1 −1 −1], [−1 1 1 1 1 −1 −1 −1 −1 −1], or [1 1 −1 −1 1−1 1 −1]. With another optional aspect, multiplying each of the first RU portions and second RU portions by a separate sequence entry of the masking sequence includes multiplying only the data tones of an RU portion by the separate sequence entry.

In another optional aspect of this embodiment, copying the ELR data in a plurality of Resource Units (RUs) includes performing constellation mapping of the ELR data. In a further optional aspect, partitioning each of the plurality of RUs into a first RU portion and a second RU portion follows the constellation mapping. In yet another optional aspect, the format of the ELR PPDU complies with the 802.11bn amendment to the IEEE 802.11 standard.

With another illustrative, non-limiting embodiment, a communication device includes one or more wireless transceivers, memory, and one or more processing modules operably coupled to the one or more wireless transceivers and the memory. The one or more processing modules are configured to generate an Enhanced Long Range physical layer protocol data unit (ELR PPDU) including a legacy preamble, an ELR preamble, and an ELR data portion including repeated ELR data. Generating the ELR data portion includes copying the ELR data in a plurality of Resource Units (RUS), including a first RU, a second RU, a third RU and a fourth RU, and partitioning each of the plurality of RUs, respectively, into a first RU portion and a second RU portion. The one or more processing modules of the communication device are further configured to multiply each of the first RU portions and second RU portions by a separate sequence entry of a masking sequence, and transmit the ELR PPDU via the one or more wireless transceivers.

This embodiment includes optional aspects. With one optional aspect, the first RU, the second RU, the third RU and the fourth RU are RU-52 resource units of a 20 MHz channel. With another optional aspect, the masking sequence is defined to have a value of [1 1 1 1 −1 1 1 −1]. In a further optional aspect, the masking sequence is one of [1 1 −1 −1 −1 1 −1 1], [−1 1 −1 1 1 1 −1], [−1 1 1 −1 −1 −1 −1 −1], or [1 1 −1 −1 1 −1 1 −1]. With another optional aspect, each of the resource units includes data tones and pilot tones. In this optional aspect, multiplying each of the first RU portions and second RU portions by a separate sequence entry of the masking sequence includes multiplying only the data tones of an RU portion by the separate sequence entry.

In another optional aspect of this embodiment, copying the ELR data in a plurality of Resource Units (RUs), includes performing constellation mapping of the ELR data. In a further optional aspect, partitioning each of the plurality of RUs into a first RU portion and a second RU portion follows the constellation mapping. In yet another optional aspect, the format of the ELR PPDU complies with the 802.11bn amendment to the IEEE 802.11 standard.

With another illustrative, non-limiting embodiment, a method for performing an Enhanced Long Range (ELR) wireless communication is provided. The method includes generating, by a first device, an ELR physical layer protocol data unit (ELR PPDU), including generating a legacy preamble, an ELR preamble, and an ELR data portion including repeated ELR data. Generating the ELR data portion includes copying the ELR data in a plurality of Resource Units (RUs), including a first RU, a second RU, a third RU and a fourth RU, and generating a masking sequence based on a generator polynomial and a seed value. The method further includes multiplying each data tone of the plurality of RUs by a sequence entry of a masking sequence. The first device of this method transmits the ELR PPDU over a wireless interface for reception by a second device.

The method of this third embodiment includes optional aspects. With one optional aspect, the generator polynomial is S(x)=x11+x9+1. In another optional aspect, the seed value has a decimal value of 1826, 1341, 1380, 550, 1257, 1523, 758, or 1428, and the masking sequence is truncated to a size of 192 sequence entries. In a further optional aspect, a generated sequence entry of 0 is mapped to 1 and a generated sequence entry of 1 is mapped to −1.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for performing an Enhanced Long Range (ELR) wireless communication, comprising:
generating, by a first device, an ELR physical layer protocol data unit (ELR PPDU), including generating a legacy preamble, an ELR preamble, and an ELR data portion including repeated ELR data, wherein generating the ELR data portion includes:
copying the ELR data in a plurality of Resource Units (RUs), including a first RU, a second RU, a third RU and a fourth RU;
partitioning each of the plurality of RUs, respectively, into a first RU portion and a second RU portion; and
multiplying each of the first RU portions and second RU portions by a separate sequence entry of a masking sequence; and
transmitting the ELR PPDU over a wireless interface for reception by a second device.

2. The method of claim 1, wherein the first RU, the second RU, the third RU and the fourth RU are RU-52 resource units of a 20 MHz channel.

3. The method of claim 1, wherein the masking sequence has a value of [1 1 1 1 −1 1 1 −1].

4. The method of claim 1, wherein the masking sequence is one of:
$$[ \begin{matrix}1 & 1 & - 1 & - 1 & - 1 & 1 & - 1 & 1\end{matrix} ] ;$$
$$[ \begin{matrix}- 1 & 1 & - 1 & 1 & 1 & 1 & - 1 & - 1\end{matrix} ] ;$$
$$[ \begin{matrix}- 1 & 1 & 1 & - 1 & - 1 & - 1 & - 1 & - 1\end{matrix} ] ; or$$
$$[ \begin{matrix}1 & 1 & - 1 & - 1 & 1 & - 1 & 1 & - 1\end{matrix} ] .$$

5. The method of claim 1, wherein multiplying each of the first RU portions and second RU portions by a separate sequence entry of the masking sequence includes multiplying only data tones of an RU portion by the separate sequence entry.

6. The method of claim 1, wherein copying the ELR data in a plurality of Resource Units (RUs), including a first RU, a second RU, a third RU and a fourth RU, includes performing constellation mapping of the ELR data.

7. The method of claim 6, wherein partitioning each of the plurality of RUs into a first RU portion and a second RU portion follows the constellation mapping.

8. The method of claim 1, wherein the format of the ELR PPDU complies with the 802.11bn amendment to the IEEE 802.11 standard.

9. A communication device, comprising:
one or more wireless transceivers;
memory; and
one or more processing modules operably coupled to the one or more wireless transceivers and the memory, wherein the one or more processing modules are configured to:
generate an Enhanced Long Range physical layer protocol data unit (ELR PPDU) including a legacy preamble, an ELR preamble, and an ELR data portion including repeated ELR data, wherein generating the ELR data portion includes:
copying the ELR data in a plurality of Resource Units (RUs), including a first RU, a second RU, a third RU and a fourth RU;
partitioning each of the plurality of RUs, respectively, into a first RU portion and a second RU portion; and
multiplying each of the first RU portions and second RU portions by a separate sequence entry of a masking sequence; and
transmit the ELR PPDU via the one or more wireless transceivers.

10. The communication device of claim 9, wherein the first RU, the second RU, the third RU and the fourth RU are RU-52 resource units of a 20 MHz channel.

11. The communication device of claim 9, wherein the masking sequence has a value of [1 1 1 1 −1 1 1 −1].

12. The communication device of claim 9, wherein the masking sequence is one of:
$$[ \begin{matrix}1 & 1 & - 1 & - 1 & - 1 & 1 & - 1 & 1\end{matrix} ] ;$$
$$[ \begin{matrix}- 1 & 1 & - 1 & 1 & 1 & 1 & - 1 & - 1\end{matrix} ] ;$$
$$[ \begin{matrix}- 1 & 1 & 1 & - 1 & - 1 & - 1 & - 1 & - 1\end{matrix} ] ; or$$
$$[ \begin{matrix}1 & 1 & - 1 & - 1 & 1 & - 1 & 1 & - 1\end{matrix} ] .$$

13. The communication device of claim 9, wherein each of the resource units include data tones and pilot tones, and wherein multiplying each of the first RU portions and second RU portions by a separate sequence entry of the masking sequence includes multiplying only the data tones of an RU portion by the separate sequence entry.

14. The communication device of claim 9, wherein copying the ELR data in a plurality of Resource Units (RUs), including a first RU, a second RU, a third RU and a fourth RU, includes performing constellation mapping of the ELR data.

15. The communication device of claim 14, wherein partitioning each of the plurality of RUs into a first RU portion and a second RU portion follows the constellation mapping.

16. The communication device of claim 9, wherein the format of the ELR PPDU complies with the 802.11bn amendment to the IEEE 802.11 standard.

17. A method for performing an Enhanced Long Range (ELR) wireless communication, comprising:
generating, by a first device, an ELR physical layer protocol data unit (ELR PPDU), including generating a legacy preamble, an ELR preamble, and an ELR data portion, wherein generating the ELR data portion includes:
copying ELR data in a plurality of Resource Units (RUs), including a first RU, a second RU, a third RU and a fourth RU;
generating a masking sequence based on a generator polynomial and a seed value; and
multiplying each data tone of the plurality of RUs by a sequence entry of a masking sequence; and
transmitting the ELR PPDU over a wireless interface for reception by a second device.

18. The method of claim 17, wherein the generator polynomial is S(x)=x¹¹+x⁹+1.

19. The method of claim 18, wherein the seed value has a decimal value of 1826, 1341, 1380, 550, 1257, 1523, 758, or 1428, and wherein the masking sequence is truncated to a size of 192 sequence entries.

20. The method of claim 17, wherein a generated sequence entry of 0 is mapped to 1 and a generated sequence entry of 1 is mapped to −1.
